(19) United States
(12) Patent Application Publication
(10) Pub. No.: US 2013/0138903 A1
(43) Pub. Date: May 30, 2013

(54) COMPUTER SYSTEM

(71) Applicants: Yoshinori Matsui, Yokohama (JP); Masami Kameda, Yokohama (JP)

(72) Inventors: Yoshinori Matsui, Yokohama (JP); Masami Kameda, Yokohama (JP)

(73) Assignee: HITACHI, LTD., Tokyo (JP)

(21) Appl. No.: 13/387,815

(22) PCT Filed: Nov. 25, 2011
(86) PCT No.: PCT/JP2011/077228

§ 371 Date: Jan. 30, 2012

(51) Int. Cl. G06F 12/16

(52) U.S. Cl. 711/162; 711/E12.103

(57) ABSTRACT

In an aspect of the invention, a primary storage system (P system) manages write times of write data of one or more primary volumes (P volumes). The P system sequentially sends journals including write data of the P volumes and values indicating order of writing the write data of the P volumes to the secondary storage system (S system). The S system sequentially stores the write data in the journals from the P system to one or more secondary volumes (S volumes) according to the values. The S system sends identification information on the latest write data of the S volumes to the P system. The P system sends a management system information to indicate the latency between the write time of the data identified with the identification information and the write time of the latest data of the P volumes at the time of receipt of the identification information.

### BACKGROUND

This invention relates to a computer system including storage systems and, in particular, relates to controlling remote copy between storage systems.

Public or business infrastructure systems bearing social foundations are required to have high availability. For this reason, the data storage market demands so-called Disaster Recovery System that will not lose data even if a storage system retaining a huge amount of data is destroyed by, for example, a disaster.

In order to meet such a demand from the market, a remote copy system which backups data applying remote copy technology is provided. This system stores identical data in two storage systems located at a primary site and a secondary site sufficiently distant from each other.

When data in a volume of the primary storage system (primary volume) is updated, the update is synchronously or asynchronously incorporated into a volume of the secondary storage system (secondary volume) by means of remote copy. Through this operation, the identity of the data is secured between the two storage systems.

Recovery point objective (RPO) is used as an important index in backup/restore operations. The RPO indicates the point-in-time back to which data is required to be restored when a system goes down because of a disaster, an accident, or a failure. The RPO represents the highest tolerance level for data loss and is an important index in planning backup.

In asynchronous remote copy, there is a time lag between a data write to the primary volume and a data write to the secondary volume. It is important to design and operate the system so that this time lag will fall within the time requested by the RPO for asynchronous remote copy.

In the following description, the time of writing the latest data to a primary volume with reference to the time of writing the data to a secondary volume is referred to as data recoverable time. The time required for the data written to the primary volume until it is written to the secondary volume is referred to as write latency.

An essential thing is to design and operate a system so that the data recoverable time and the write latency will meet the demand by the RPO. For example, a technique to monitor the data recoverable time in asynchronous remote copy is disclosed in JP 2010-146198 A. The management computer in this system periodically acquires the latest sequence number and the number of data retained in the buffer of the primary storage system, stores them in relation to their acquisition times, and estimates the data recoverable time with the stored information.

### CITATION LIST

Patent Document 1 JP 2010-146198 A

### SUMMARY

To design or operate a system which performs asynchronous remote copy, accurate monitoring of the write latency is important. For example, only the write latency in a particular copy group (a group of one or more copy pairs) for some specific application might be long depending on the balance between the performance of the application hosts or the volumes and the bandwidth between sites.

In the case of a system operating three applications (applications A, B, and C), if the application host A writes to volumes more frequently than the other application hosts and the bandwidth between sites is narrower, the write latency in the copy group A for the application A is relatively longer than the copy groups for the other applications B and C.

An administrator who can detect the foregoing situation attains satisfactory write latencies of the copy groups by, for example, adjusting the workloads of the applications. If, however, the administrator cannot know accurate write latencies, he or she cannot detect the foregoing situation. The administrator is obliged to think of increasing the bandwidth. Increasing the bandwidth results in high cost and the investment might be even a waste. Accordingly, a technique that adequately monitors the write latency is demanded for a system which performs asynchronous remote copy.

An aspect of this invention is a computer system including a primary storage system including one or more primary volumes, a secondary storage system including one or more secondary volumes for storing copy data of the one or more primary volumes received from the primary storage system via a network, and a management system for managing the primary storage system, wherein the primary storage system manages write times of write data of the one or more primary volumes. The primary storage system sequentially sends journals, which include write data of the one or more primary volumes and values indicating order of writing the write data to the one or more primary volumes, to the secondary storage system. The secondary storage system sequentially stores the write data included in the journals received from the primary storage system to the one or more secondary volumes in accordance with the values indicating the order of writing. The secondary storage system sends identification information on the latest write data of the one or more secondary volumes to the primary storage system. The primary storage system sends the management system information to indicate a latency between the write time of the write data identified with the identification information and the write time of the latest write data of the one or more primary volumes at the time of receipt of the identification information.

An aspect of this invention achieves more adequate monitoring of write latencies for a system which performs asynchronous remote copy.

### BRIEF DESCRIPTION OF THE DRAWINGS

FIG. 1 is a drawing schematically illustrating an architecture of a computer system in an embodiment of this invention;

FIG. 2 is a drawing schematically illustrating a configuration of an application server in the embodiment;

FIG. 3 is a drawing schematically illustrating a configuration of a management computer in the embodiment;

FIG. 4 is a drawing schematically illustrating a configuration of a storage system in the embodiment;

FIG. 5 is a drawing illustrating transition of the state of a copy pair in the embodiment;

FIG. 6 is a drawing explaining a flow that asynchronous remote copy incorporates a write to a primary volume into a secondary volume in the embodiment;

FIG. 7 is a drawing illustrating an exemplary configuration of a consistency group management table in the embodiment;

FIG. 8 is a drawing illustrating an exemplary configuration of a copy pair management table in the embodiment;

FIG. 9 is a drawing illustrating an exemplary configuration of a primary journal management table in the embodiment;

FIG. 10 is a drawing illustrating an exemplary configuration of a secondary journal management table in the embodiment;

FIG. 11 is a drawing illustrating an exemplary configuration of an own system's time management table in the embodiment;

FIG. 12 is a drawing illustrating an exemplary configuration of a counter system's time management table in the embodiment;

FIG. 13 is a drawing illustrating an exemplary configuration of a copy group management table in the embodiment;

FIG. 14 is a drawing illustrating an exemplary configuration of a journal transfer command in the embodiment;

FIG. 15 is a drawing illustrating an exemplary configuration of a set of return values to a journal transfer command in the embodiment;

FIG. 16 is a drawing illustrating a processing flow performed by a copy control program when a primary storage system receives a command to create copy pairs from a management computer in the embodiment;

FIG. 17 is a drawing illustrating a processing flow performed by an input and output control program in the primary storage system upon receipt of a write command from an application server in the embodiment;

FIG. 18 is a drawing illustrating a processing flow performed by a journal request program in the secondary storage system to issue a journal transfer command and to collect journals in the embodiment;

FIG. 19 is a drawing illustrating a processing flow performed by a journal transfer program in the primary storage system in response to a journal transfer command in the embodiment;

FIG. 20 is a drawing illustrating a processing flow performed by a secondary volume incorporating program in the secondary storage system to incorporate a journal into the secondary volume in the embodiment;

FIG. 21 is an exemplary image presented by a remote copy control program in the management computer in an image output device in the embodiment; and

FIG. 22 is a drawing illustrating a method of calculating a recoverable time and a write latency in the embodiment.

### DETAILED DESCRIPTION OF THE PREFERRED EMBODIMENTS

Hereinafter, a preferred embodiment of this invention will be described. For clarity of explanation, the following description and the accompanying drawings contain omissions and simplifications as appropriate. Furthermore, repetitive explanation will be omitted if not necessary for clarity of explanation.

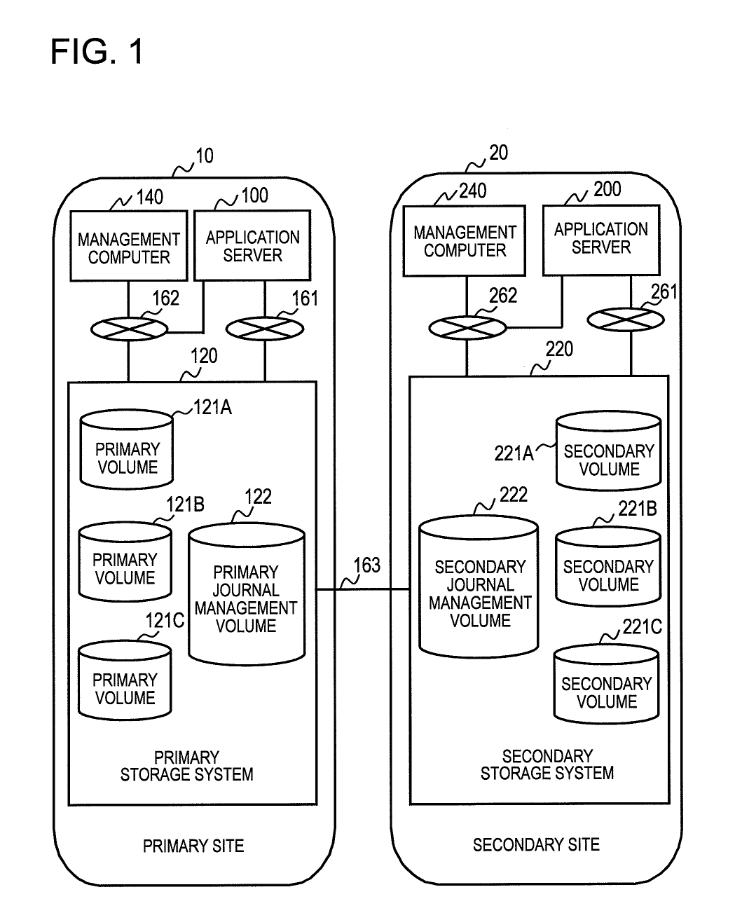

FIG. 1 schematically illustrates an exemplary architecture of a computer system in this embodiment. The computer system includes a computer system in a primary site 10 and a computer system in a secondary site 20. In the primary site 10, a computer system is installed in which application programs are working. The secondary site 20 is located physically distant from the primary site 10 and a computer system is installed that takes over jobs in the primary site 10 in case the primary site 10 suffers from a disaster.

The computer system in the primary site 10 includes an application server 100, a storage system (primary storage system) 120 the application server 100 accesses, and a management computer (primary management computer) 140 that manages the application server 100 and the primary storage system 120. The number of computers and storage systems depends on the design.

The application server 100 and the storage system 120 are connected with a data network 161. The data network 161 is a data communication network and is a storage area network (SAN) in this architecture. The data network 161 may be a network other than the SAN, such as an IP network, as long as it is a network for data communication.

The application server 100, the storage system 120, and the management computer 140 are connected with a management network 162. The management network 162 is an IP network in this architecture. The management network 162 may be a network other than the IP network, such as a SAN, as long as it is a network for management data communication.

The data network 161 and the management network 162 may be the same network.

In similar, the secondary site 20 includes an application server 200, a storage system (secondary storage system) 220 the application server 200 accesses, and a management computer (secondary management computer) 240 for managing the application server 200 and the secondary storage system 220.

The application server 200 and the storage system 220 are connected with a data network 261. The application server 200, the storage system 220, and the management computer 240 are connected with a management network 262. These networks 261, 262 are similar to the networks in the primary site 100. In this example, the application server and the management computer in one site cannot communicate with the storage system in the other site, but they may be connected to be able to communicate.

In the exemplary configuration of FIG. 1, the primary storage system 120 has three data volumes (primary volumes) 121A to 121C and a primary journal management volume 122. The secondary storage system 220 has three data volumes (secondary volumes) 221A to 221C and a secondary journal management volume 222. The data volumes are logical volumes which are logical storage areas in the units that the application servers 100, 200 and the management computers 140, 240 can recognize. The journal volumes are logical volumes which are logical storage areas for storing update history of writes to data volumes.

The primary storage system 120 and the secondary storage system 220 are connected with an inter-storage network 163 to be able to communicate with each other. The primary storage system 120 performs remote copy of a volume with the secondary storage system 220. The computer system in this embodiment performs asynchronous remote copy. The asynchronous remote copy notifies the application server of the success of I/O after data write to a cache or the primary volume but before the completion of write to the secondary volume.

The primary storage system 120 stores write data received from the application server 100 to one of the primary volumes 121A to 121C and the primary journal management volume 122. An entry stored in the primary journal management volume 122 is called journal. A journal contains user data and, in addition, a sequential number, which is the identifier of the user data, and write time information. These will be described later. The primary storage system 120 transfers a journal in the primary journal management volume 122 to the secondary storage system 220.

The secondary storage system 220 stores the journal received from the primary storage system 120 to the secondary journal management volume 222. The secondary storage system 220 stores the user data in the journal retained in the secondary journal management volume 222 to one of the secondary volumes 221A to 221C. As a result of this operation, the data in one of the primary volumes 121A to 121C is copied to one of the secondary volumes 221A to 221C.

Remote copy is performed between data volumes which constitute a copy pair. For example, the primary volume 121A and the secondary volume 221A constitute a copy pair; the primary volume 121B and the secondary volume 221B constitute a copy pair; and the primary volume 121C and the secondary volume 221C constitute a copy pair. In the example of FIG. 1, the primary volumes 121A to 121C constitute a consistency group and the secondary volumes 221A to 221C constitute a consistency group.

Asynchronous remote copy makes the order of copy to the secondary volumes the same as the order of data write (the order of data update) to the primary volumes. The same order is preserved between consistency groups. That is to say, the order of writing data to the primary volumes in a consistency group in the primary storage system 120 is the same as the order of writing data (the order of copy) to the corresponding consistency group in the secondary storage system 220.

In the example of FIG. 1, the order of write to the primary volumes 121A to 121C for all data is the same as the order of write to the secondary volumes 221A to 221C for all data. The system of this embodiment assigns journals sequential numbers which are unique in the consistency group to indicate the order of write to the primary volumes 121A to 121C. The storage systems 120, 220 and the management computers 140, 240 can obtain the position in sequence of a journal in the consistency group with reference to the sequential number of the journal.

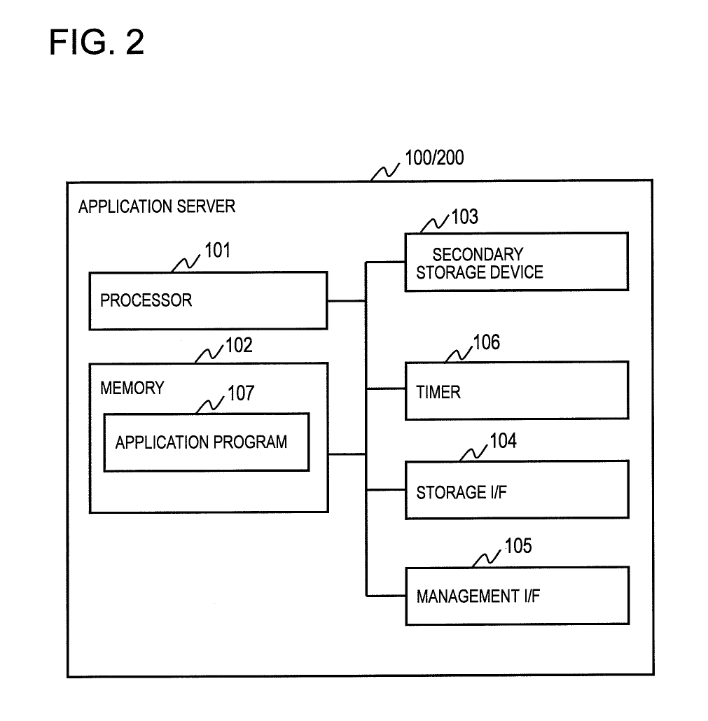

FIG. 2 is a drawing schematically illustrating a configuration of the application servers 100, 200. The application servers 100, 200 each include a processor 101, a memory 102, a non-volatile secondary storage device 103, a storage I/F 104, a management I/F 105, and a timer 106, which are interconnected. The processor 101 works in accordance with programs stored in the memory 102. The programs and data retained in the secondary storage device 103 are loaded to the memory 102.

The storage I/F 104 is a network interface for connecting to the data network 161 or 261. The storage I/F 104 exchanges data and control commands with the storage system 120 or 220 via the data network 161 or 261.

The management I/F 105 is a network interface for connecting to the management network 162 or 262. The management I/F 105 exchanges management data and control commands with the storage system 120 or 220 via the management network 162 or 262. The management I/F 105 further exchanges management data and control commands with the management computer 140 or 240 via the management network 162 or 262.

The memory 102 stores an application program 107. The application program 107 reads data from or write data to the data volumes 121A to 121C or 221A to 221C to perform tasks. It should be noted that the platforms of the application servers 100, 200 are open systems or mainframes.

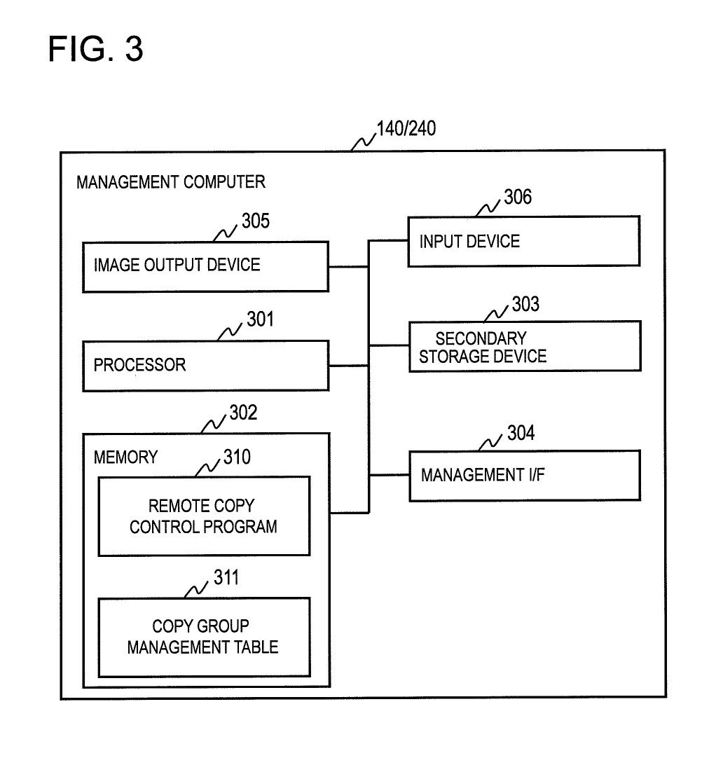

FIG. 3 is a drawing schematically illustrating a configuration of the management computers 140, 240. A program for managing the storage systems 120, 220 runs on the management computers 140, 240. The management computers 140, 240 each can issue a command for the connected storage system 120 or 220 to copy a volume in the storage system to the other storage system.

The management computers 140, 240 each include a processor 301, a memory 302, a secondary storage device 303, a management I/F 304, an image output device 305, and an input device 306, which are interconnected. The image output device 305 is typically a liquid crystal display device and the input device 306 is typically a keyboard and a mouse. The administrator can acquire necessary information with the image output device 305 and input necessary information with the input device 306.

The management I/F 304 is a network interface for connecting to the management network 162 or 262. The management I/F 304 exchanges management data and control commands with the storage system 120 or 220 via the management network 162 or 262. The management I/F 304 exchanges management data and control commands with the application servers 100 or 200 via the management network 162 or 262.

The processor 301 works in accordance with programs stored in the memory 302. The programs and data retained in the secondary storage device 303 are loaded to the memory 302. In FIG. 3, the memory 302 retains a remote copy control program 310 and a copy group management table 311.

The remote copy control program 310 manages the storage system 120 or 220. The remote copy control program 310 provides the administrator of the storage systems 120, 220 or an external program with some functions. Specifically, the remote copy control program 310 configures a copy group management table 311 in the management computer on which the program is running (management computer 140 or 240) through inputs from the user of the management computer on which the program is running (management computer 140 or 240) or an external program.

The remote copy control program 310 collects information on issuance of a command about copying a data volume between storage systems 120 and 220 and the state of the storage system 120 or 220 in response to an operation by the user of the management computer on which the program is running (management computer 140 or 240) or invocation by an external program. The remote copy control program 310 presents the information collected from the storage system 120 or 220 and other information.

The copy group management table 311 is a control table used by the remote copy control program 310 when it instructs the storage system 120 or 220 to perform some operation. Details of the copy group management table 311 will be described later.

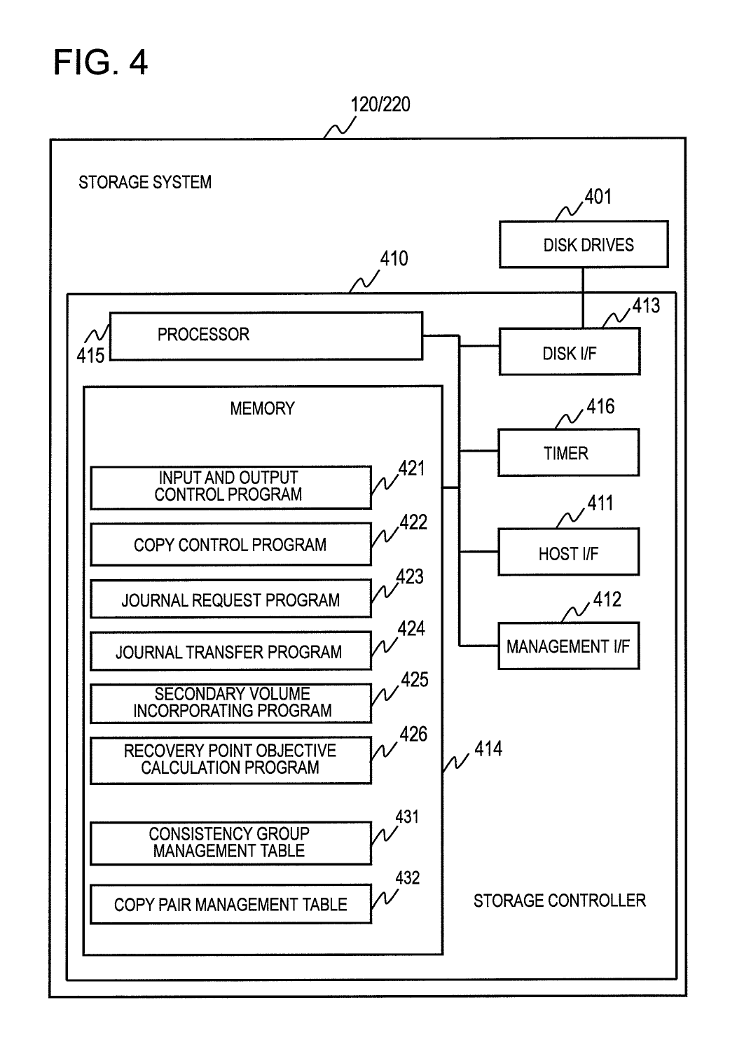

FIG. 4 is a drawing schematically illustrating a configuration of the storage systems 120, 220. The storage systems 120, 220 store the data to be handled by the application servers 100, 200, respectively. The storage systems 120, 220 each include disk drives 401 and a storage controller 410. The disk drives 401 include a plurality of volumes and store the data requested to be written by the application server 100 or 200. The storage controller 410 controls operations of the storage system 120 or 220.

The storage controller 410 includes a host I/F 411, a management I/F 412, a disk I/F 413, a memory 414, a processor 415, and a timer 416. The host I/F 411 is a network interface for connecting the storage controller 410 to the data network 161 or 261. The host I/F 411 exchanges data and control commands with the application server 100 or 200 via the data network 161 or 261.

The management I/F 412 is a network interface for connecting the storage controller 410 to the management network 162 or 262. The management I/F 412 exchanges data and control commands with the management computers 140 or 240 via the management network 162 or 262. The disk I/F 413 is an interface for connecting the storage controller 410 to the disk drives 401.

The processor 415 executes programs retained in the memory 414. In FIG. 4, the memory 414 retains an input and output control program 421, a copy control program 422, a journal request program 423, a journal transfer program 424, a secondary volume incorporating program 425, and a recovery point objective calculation program 426. Moreover, the memory 414 retains a consistency group management table 431 and a copy pair management table 432.

The input and output control program 421 reads data from or writes data to a data volume in response to a read command or a write command from the application server 100 or 200. The input and output control program 421 creates a journal from a write command and write data and stores the journal to the journal management volume 122 or 222.

The copy control program 422 controls volume copy in response to a command about the volume copy from either one of the management computer 140 or 240 and the application server 100 or 200. As described above, volume copy is asynchronous remote copy by transferring journals from the primary storage system 120 to the secondary storage system 220.

The journal request program 423 is a program that runs on the secondary storage system 220 in remote copy. The journal request program 423 requests the primary storage system 120 to transfer journals in the journal management volume 122 to the secondary storage system 220. The journal request program 423 operates asynchronously with the input and output control program 421 and the secondary volume incorporating program 425.

One storage system can function in two ways: as a primary storage system and as a secondary storage system. Accordingly, this embodiment is described assuming that each storage system has programs that run on the both kinds of storage systems. A storage system that only functions as either primary storage system or secondary storage system may have programs and information required by the either kind of storage system.

The journal transfer program 424 is a program that runs on the primary storage system 120 in remote copy. It receives a journal transfer command from the journal request program 423 running on the secondary storage system 220 and returns journals in the primary storage system 120.

The secondary volume incorporating program 425 is a program that runs on the secondary storage system 220 in remote copy. It incorporates (stores) the user data in the journals the journal request program 423 receives from the primary storage system 120 into the secondary volume based on the information included in the journals

The recovery point objective calculation program 426 estimates a recoverable time and a write latency. The recoverable time is the time in the state (of data) to which the primary storage system 120 can be restored with copy data held in the secondary storage system 220 in case of a failure. The write latency is the time after write data is stored in a primary volume until the data is copied (stored) to the secondary volume.

The recovery point objective calculation program 426 in this embodiment refers to the time information included in a journal to estimate the recoverable time and the write latency.

As will be described later, a journal includes information on the write time at the primary storage system 120. The write time is determined by either one of the application server 100 or 200 and the primary storage system 120. For example, in a mainframe system, the application servers 100, 200 put information on the time indicated by the timer 106 in a write command to send the command. A journal includes this time information for the information on the write time.

In an open system, the storage controller 410 in the primary storage system 120 puts information on the time indicated by the timer 416 in a journal. For example, the storage controller 410 puts the time of receipt of a write command and write data or the time of storing the write data to the primary volume for the information on the write time in the journal.

The consistency group management table 431 manages consistency groups. As described above, a consistency group is a group in which write order in remote copy is preserved. The copy pair management table 432 manages pairs of primary volumes and secondary volumes in remote copy. Details of these tables will be described later.

In the foregoing explanation, programs are executed by a processor to perform predetermined processing using storage devices and interfaces. For this reason, the explanations having the subjects of program in this embodiment and other embodiments may be explanations having the subjects of processor. Alternatively, processing performed by a program is processing performed by the apparatus or the system on which the program is running.

The processor works in accordance with a program to work as an operation part (means) for implementing a predetermined function. The processor also works as operation parts (means) for performing a plurality of jobs of programs. For example, a processor in a storage system works as a copy controller or a recovery point objective calculator. An apparatus or a system including a processor is an apparatus or a system including these operation parts (means).

In this embodiment and other embodiments, information used by the system does not depend on the data structure but may be expressed in any data structure. For example, a data structure appropriately selected from table, list, database, and queue can store the information. Information to be used by the system is stored in a storage area in a data storage device. Although expressions such as identification information, identifiers, names, IDs, and numbers are used to explain the substance of information, these can be replaced with one another.

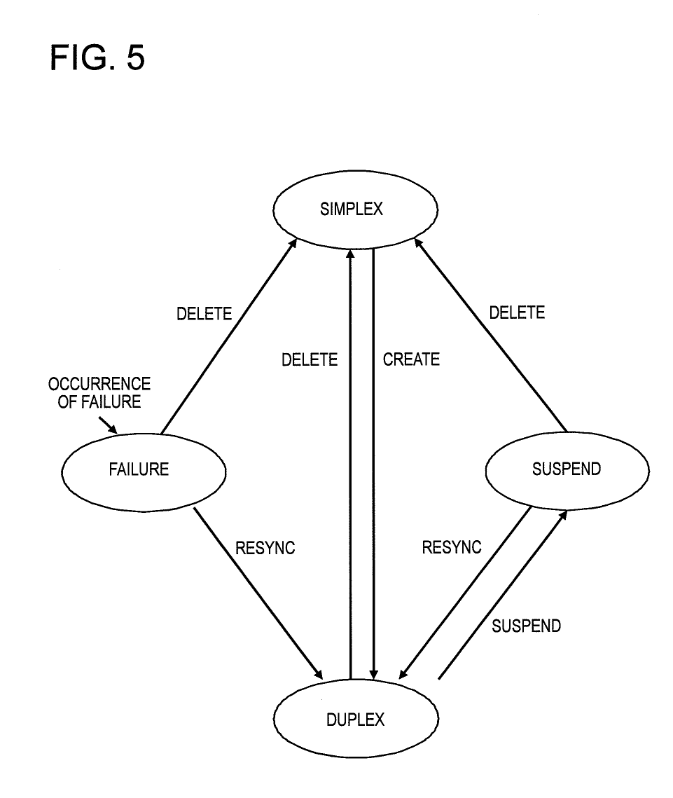

FIG. 5 illustrates transition of the state of a copy pair. In this example, there are states of Duplex, Suspend, Failure, and Simplex for a copy pair. In the state of Duplex, an update of the primary volume is incorporated into the secondary volume. In the state of Suspend, copy operation is being suspended. In the state of Failure, remote copy is not available because of a communication failure, for example. In the state of Simplex, the copy pair is not configured.

The copy control program 422 controls copy pairs. The copy control program 422 performs the following operations in its copy control: creating, suspending, resynchronizing (resync), deleting a pair, and acquiring a state. Either one of the application server 100 or 200 and the management computer 140 or 240 can request the copy control program 422 to perform any one of these operations. In creating a copy pair, the copy control program 422 newly creates a copy pair. The state of the copy pair turns from Simplex into Duplex.

The suspending holds data copy from the primary volume to the secondary volume for a while. The state of the copy pair turns from Duplex into Suspend. Upon receipt of instruction to suspend a copy pair, the copy control program 422 does not incorporate a data change in the primary volume into the secondary volume. In an example, the copy control program 422 stops copying data between two volumes after the latest update to the primary volume is copied to the secondary volume.

The resync synchronizes the primary volume with the secondary volume so that the data in the primary volume will be identical to the data in the secondary volume. The state of the copy pair turns from Failure or Suspend into Duplex. In an example of the resync, after the data between two volumes becomes identical, the copy control program 422 resumes copying data between the two volumes.

The deleting a pair cancels a pair created by the creating. The state of the copy pair turns from one other than Simplex into Simplex. Upon receipt of a request to acquire the state, the copy control program 422 transmits the information on the state of the copy pair to the request source. As to the volumes included in the storage systems 120 and 220, information on the state of volumes that constitute copy pairs is included in the copy pair management table 432. After creating, resynchronizing, or suspending, the copy control program 422 updates the copy pair management table 432. Also, as the result of the processing, the program 432 may send information on the state of the copy pair to the management computer 140 or 240.

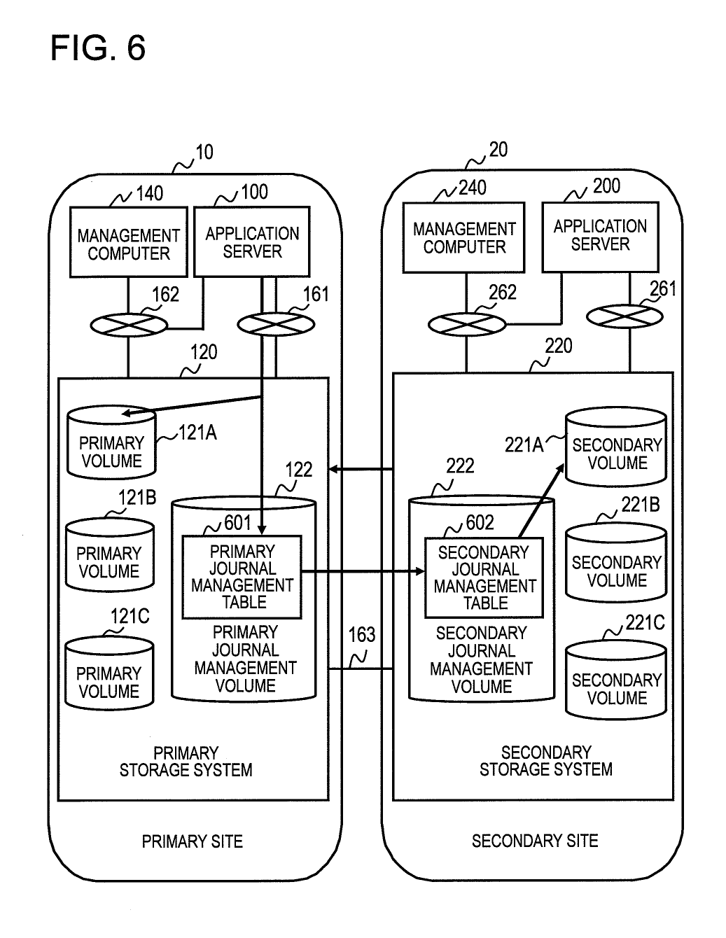

Now with reference to FIG. 6, a flow of incorporating a write to the primary volume into the secondary volume by asynchronous remote copy will be explained. The primary storage system 120 receives a write command and write data (user data) from the application server 100 via the network 161. The primary storage system 120 stores the user data in the primary volume 121A, and further, creates a journal including the user data and stores the journal in the primary journal management volume 122.

The primary journal management volume 122 includes a primary journal management table 601. The journal is stored in the primary journal management table 601. Details of the primary journal management table 601 will be described later.

The secondary storage system 220 sends a command to read the journal to the primary storage system 120 via the network 163. In response to the command, the primary storage system 120 sends the journal in the primary journal management table 601 to the secondary storage system 220.

The secondary storage system 220 receives the journal transferred via the network 163 and stores it in the secondary journal management table 602 in the secondary journal management volume 222. Then, the secondary storage system 220 stores the user data in the journal in the secondary journal management table 602 to the secondary volume 221A (incorporating the data into the secondary volume).

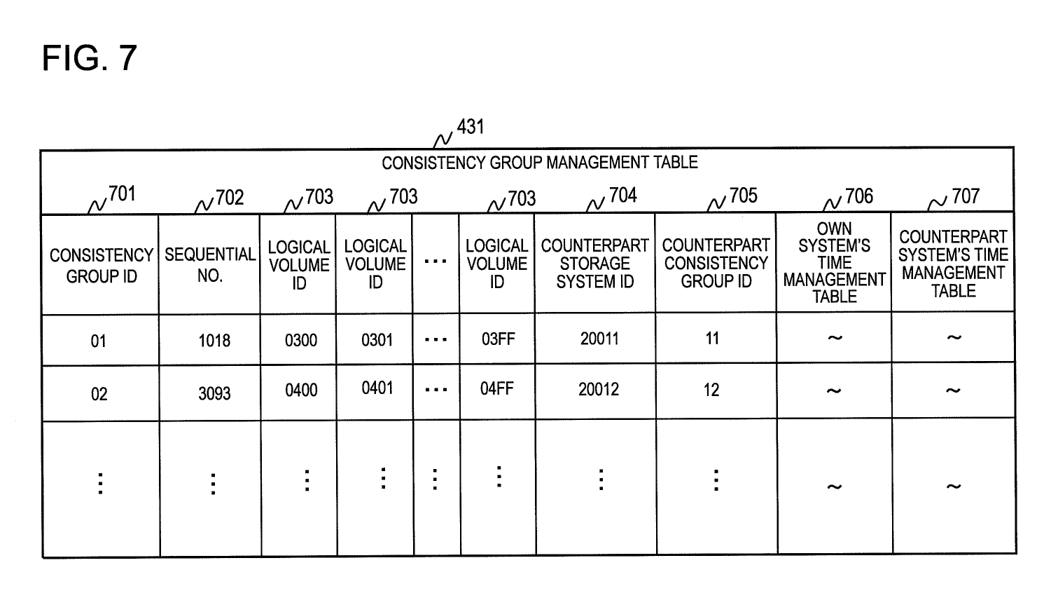

FIG. 7 illustrates an exemplary configuration of the consistency group management table 431 in a storage system. The consistency group management table 431 includes a column 701 of consistency group IDs, a column 702 of sequential numbers, a plurality of columns 703 of logical volume IDs, a column 704 of counterpart storage system IDs, a column 705 of counterpart consistency group IDs, a column 706 of own system's time management tables, and a column 707 of the counterpart system's time management tables.

The consistency group management table 431 manages a list of primary volumes or secondary volumes in each consistency group and information on the counterpart consistency group and the counterpart storage system including it.

The consistency group management table 431 includes, for each consistency group in the own storage system, information of its ID, the IDs of volumes included therein, the ID of the counterpart storage system, and the ID of the consistency group in the counterpart storage system. The primary storage system 120 is the counterpart storage system (counterpart system) of the secondary storage system 220 and vice versa.

Each field in the sequential number column 702 indicates the sequence number of the latest journal in the consistency group. The storage systems 120 and 220 assign sequence numbers to journals. The sequential numbers are the identifiers of the journals and they are information to indicate the order of journals retained in the journal management table 601 or 602.

In this example, the sequential numbers indicate the order of journals within the consistency group. The sequential number column 702 indicates sequential numbers assigned to the latest journals in individual consistency groups in the journal management table 601 or 602.

The own system's time management table column 706 and the counterpart system's time management table column 707 respectively store the own system's time management tables and the counterpart system's time management tables for individual consistency groups. The time management tables will be described later.

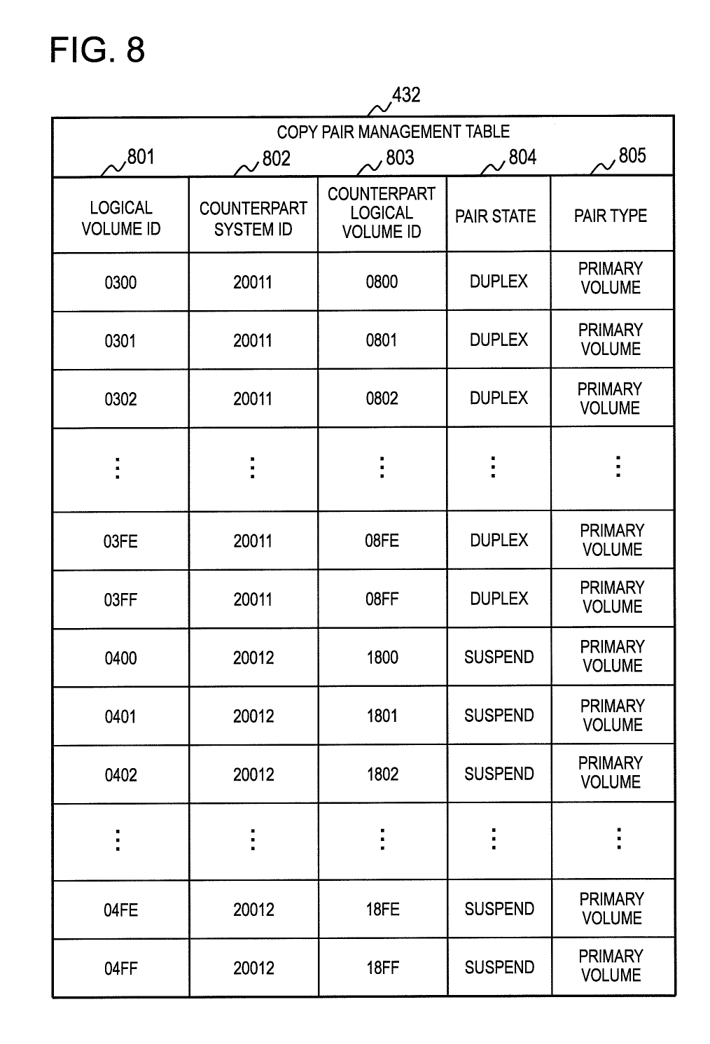

FIG. 8 illustrates an exemplary configuration of the copy pair management table 432 in a storage system. The copy pair management table 432 includes a column 801 of logical volume IDs, a column 802 of counterpart storage system IDs, a column 803 of counterpart logical volume IDs, a column 804 of the pair state, and a column 805 of the pair type.

The logical volume ID column 801 stores the IDs of logical volumes in the own storage system. The counterpart logical volume ID column 803 stores the IDs of logical volumes in counterpart storage systems that form copy pairs with the logical volumes in the own storage system. The counterpart storage system ID column 802 stores the IDs of the counterpart storage systems. The pair state column 804 and the pair type column 805 store information indicating the state of the copy pair and information indicating whether the logical volume in the own storage system is a primary volume or a secondary volume, respectively, for each logical volume.

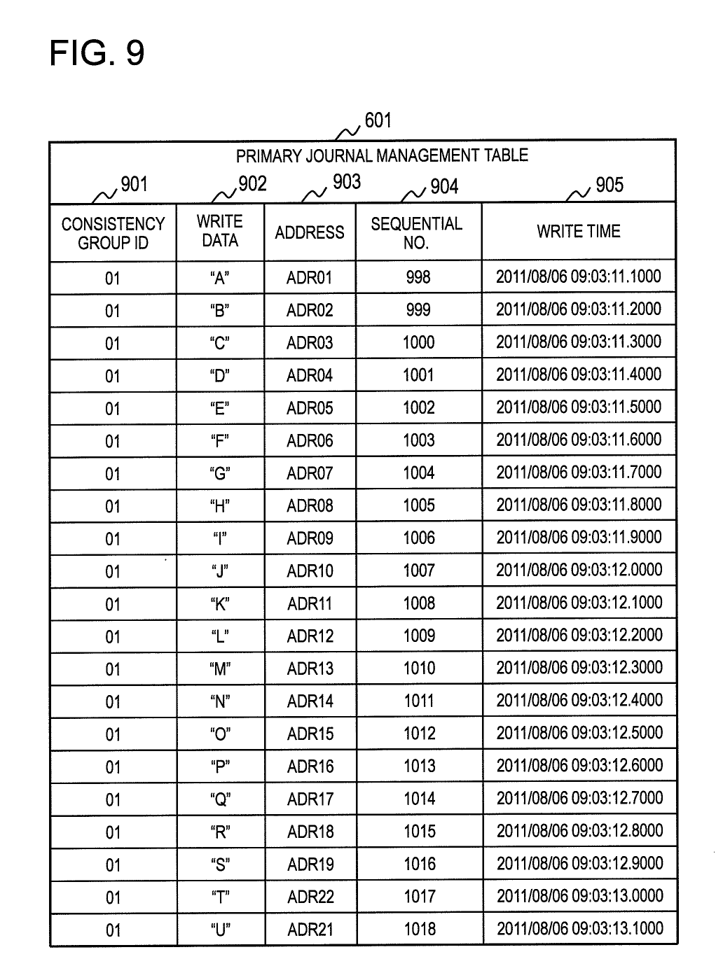

FIG. 9 illustrates an exemplary configuration of the primary journal management table 601. The primary journal management table 601 includes a column 901 of consistency group IDs, a column 902 of write data, a column 903 of addresses, a column 904 of sequential numbers, and a column 905 of write times. The records are the journals in the primary journal management table 601. When the primary storage system 120 receives a write I/O (a write command and write data), the input and output control program 421 adds a new journal to the primary journal management table 601.

The consistency group ID column 901 stores the IDs of the consistency groups the volumes to store write data (user data) in the individual journals belong to. The consistency groups are defined within the primary storage system 120. The write data column 902 stores the write data in the individual journals and the address column 903 stores their addresses.

The sequential number column 904 stores sequential numbers assigned to the journals. The write time column 905 stores the write times of the write data in the journals. As described above, the write times are provided by the application server 100 or the primary storage system 120.

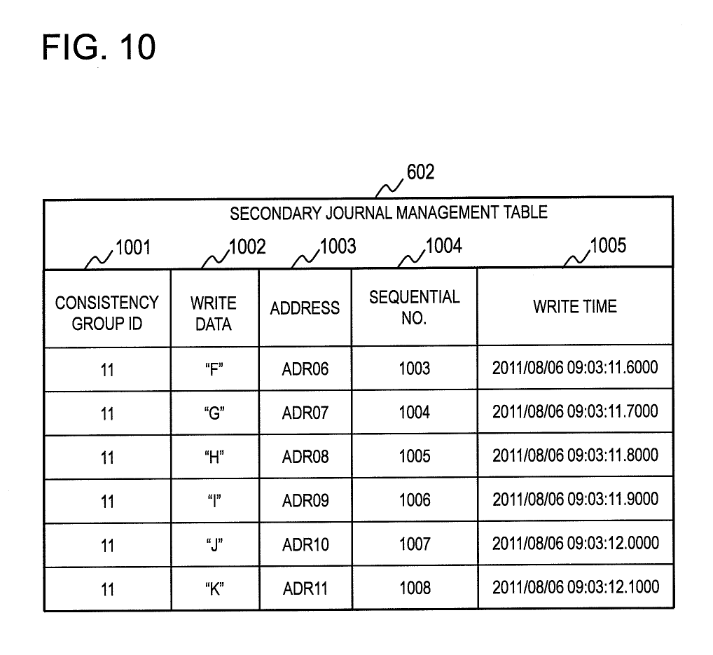

FIG. 10 illustrates an exemplary configuration of the secondary journal management table 602. The secondary journal management table 602 stores journals transferred from the primary storage system 120. The records are the journals in the secondary journal management table 602. The journal request program 423 adds journals received from the primary storage system 120 to the secondary journal management table 602.

The secondary journal management table 602 includes a column 1001 of consistency group IDs, a column 1002 of write data, a column 1003 of addresses, a column 1004 of sequential numbers, and a column 1005 of write times. In this example, information in the journals stored by the secondary journal management table 602 is the same as the one in the primary journal management table 601.

The consistency group ID column 1001 stores the IDs of the consistency groups the secondary volumes to store the data in the individual journals belong to. The information to be stored in the write data column 1002, the address column 1003, the sequential number column 1004, and the write time column 1005 for each journal is the same as the information stored in the write data column 902, the address column 903, the sequential number column 904, and the write time column 905 in the primary journal management table 601.

The primary storage system 120 may transfer only a part of information in a journal to the secondary storage system 220. For example, the primary storage system 120 transfers a journal including the information other than the consistency group ID to the secondary storage system 220. The secondary storage system 220 may add other information to the received journal or modify a part of the information in the journal (for example, the consistency group ID) to store the information in the secondary journal management table 602.

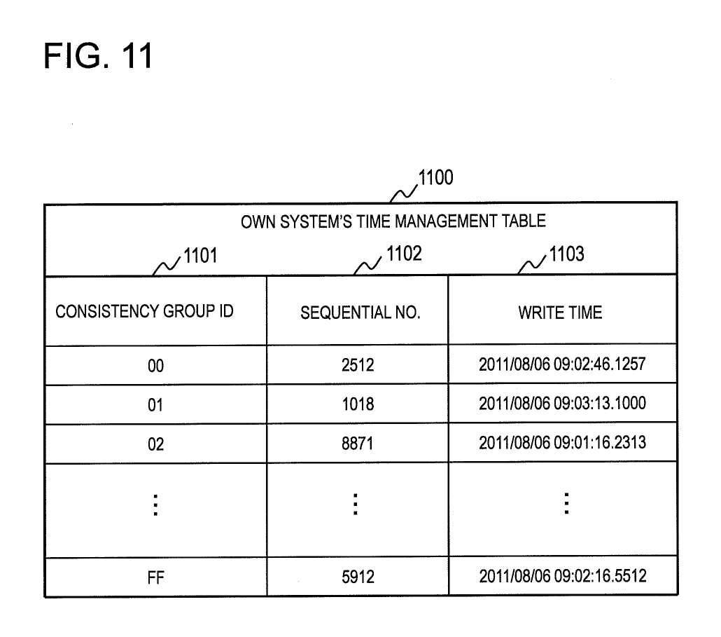

FIG. 11 illustrates an exemplary configuration of the own system's time management table 1100. The own system's time management table 1100 is included in the consistency group management table 431 and each consistency group has one table assigned. The own system's time management table 1100 manages time information of the latest journal written to a volume (the journal written lastly) in the relevant consistency group in the own storage system.

Specifically, the own system's time management table 1100 includes a column 1101 of consistency group IDs, a column 1102 of sequential numbers, and a column 1103 of write times. The consistency group ID column 1101 stores the IDs of consistency groups in the own system.

In the primary storage system 120, the sequential number column 1102 stores the sequence numbers of the journals including the latest data written to primary volumes in the individual consistency groups (the data lastly written to the individual consistency groups).

In the secondary storage system 220, the sequential number column 1102 stores the sequence numbers of the journals including the latest data written (incorporated) to secondary volumes in the individual consistency groups.

The write time column 1103 stores information on write times included in the journals identified with the sequential numbers.

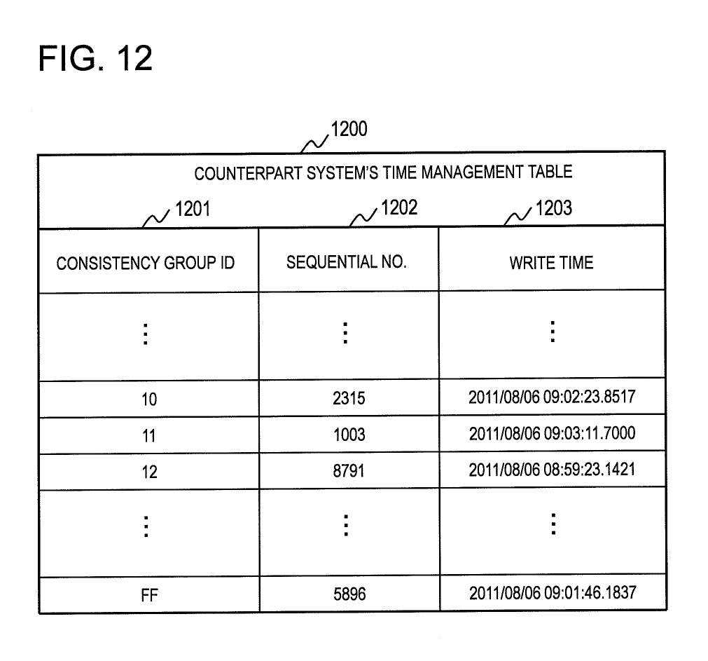

FIG. 12 illustrates an exemplary configuration of the counterpart system's time management table 1200. The counterpart system's time management table 1200 is included in the consistency group management table 431 and each consistency group has one table assigned. The counterpart system's time management table 1200 manages time information of the latest journal written to a volume (the journal lastly written) in the relevant consistency group in the counterpart storage system.

Specifically, the counterpart system's time management table 1200 includes a column 1201 of consistency group IDs, a column 1202 of sequential numbers, and a column 1203 of write times. The consistency group ID column 1201 stores the IDs of consistency groups in the counterpart system.

In the primary storage system 120, the sequential number column 1202 stores the sequence numbers of the journals including the latest data written to secondary volumes in the individual consistency groups (the data lastly written to the individual consistency groups). The primary storage system 120 receives the sequential numbers of the latest journals from secondary storage systems 220 and stores them in the sequential number column 1202.

As will be described later, the journal request program 423 in the secondary storage system 220 transmits a journal transfer command (a read command) to the primary storage system 120. This journal transfer command includes the sequential number of the latest journal written to the consistency group requesting a new journal.

The journal transfer program 424 in the primary storage system 120 stores the sequential number of the latest journal included in the received journal transfer command to the field of the sequential number column 1202 for the relevant consistency group.

In the secondary storage system 220, the sequential number column 1202 stores the sequence numbers of the journals including the latest data written to primary volumes in the individual consistency groups. The secondary storage system 220 receives the sequential number of the latest journal from primary storage systems 120 and stores them in the sequential number column 1202.

As will be described later, the journal transfer program 424 in the primary storage system 120 transmits a set of return values including a journal in response to a journal transfer command (journal read command) from the secondary storage system 220. This set of return values (response) includes the sequence number and the write time of the journal including the latest data written to the consistency group including the journal. The journal request program 423 in the secondary storage system 220 acquires the sequence number and the write time of the latest journal from the set of return values and stores them in the fields of the sequential number column 1202 and the write time column 1203 for the relevant consistency group.

The write time column 1203 stores information on write times included in sets of return values (responses) to journal transfer commands.

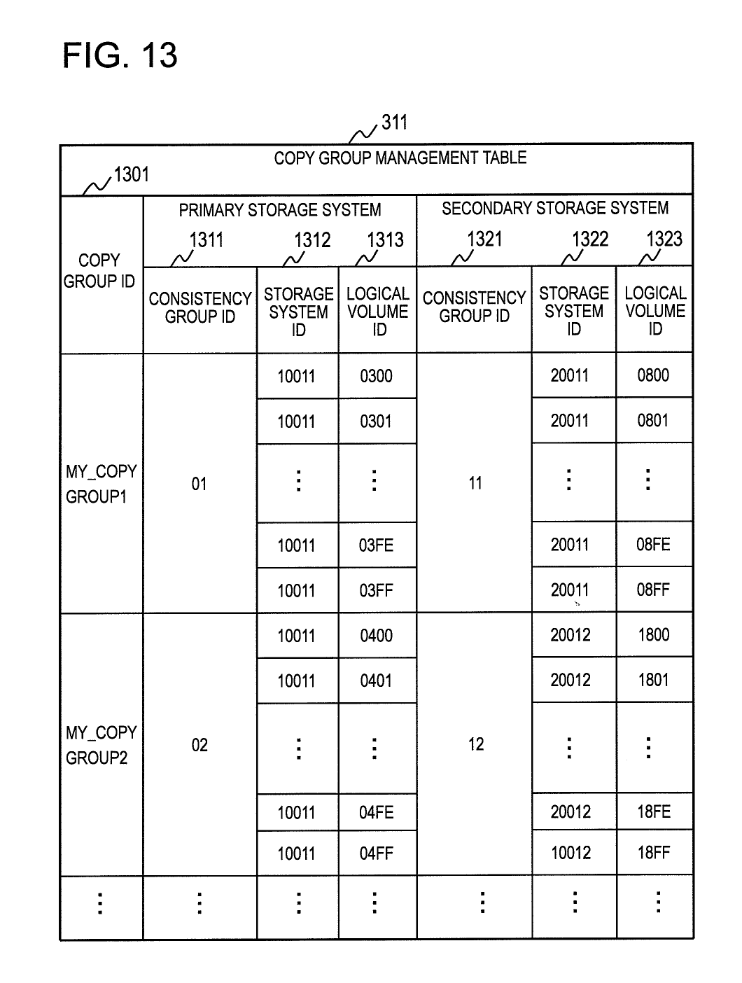

FIG. 13 illustrates an exemplary configuration of the copy group management table 311 retained by each of the management computers 140 and 240. The administrator operates the management computer 140 or 240 to create the copy group management table 311. A copy group is a group of copy pairs as seen from the administrator. The administrator provides the copy group management table 311 with data

The copy group management table 311 manages information on copy groups identified with the individual IDs in the copy group ID column 1301. The copy group management table 311 includes a column 1311 of consistency group IDs, a column 1312 of storage system IDs, and a column 1313 of logical volume IDs for the primary storage system. The copy group management table 311 includes a column 1321 of consistency group IDs, a column 1322 of storage system IDs, and a column 1323 of logical volume IDs for the secondary storage system.

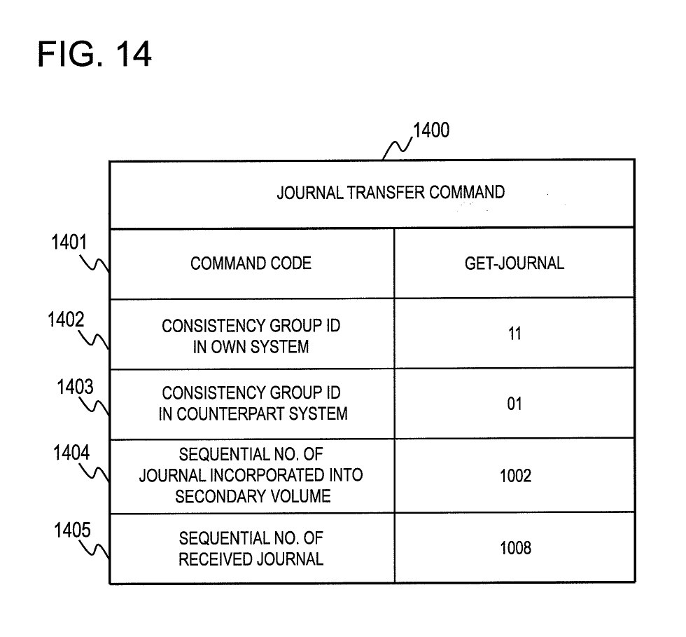

FIG. 14 illustrates an exemplary configuration of a journal transfer command 1400. The journal transfer command 1400 is a command for the primary storage system 120 to transfer one or more journals to the secondary storage system 220. The journal request program 423 in the secondary storage system 220 creates a journal transfer command 1400 and sends it to the primary storage system 120.

The journal transfer command 1400 includes a section 1401 of a command code, a section 1402 of a consistency group ID in the own system, a section 1403 of a consistency group ID in the counterpart system, a section 1404 of the sequential number of a journal already incorporated into the secondary volume, and a section 1405 of the sequential number of a received journal.

The command code section 1401 stores the type of command, namely, data indicating the command is a journal transfer command. The section 1402 of a consistency group ID in the own storage system stores the ID of the consistency group in the secondary storage system 220 for the journal(s) requested to be transferred, namely, the consistency group ID in the secondary volume(s) to store the journal(s) requested to be transferred.

The section 1403 of a consistency group ID in the counterpart system stores the ID of the consistency group in the primary storage system 120 for the journal(s) requested to be transferred, namely, the consistency group ID of the primary volume(s) to store the journal(s) requested to be transferred. The primary storage system 120 is the storage system which the secondary storage system 220 requests to transfer journal(s). The journal request program 423 ascertains the consistency group ID in the counterpart system with reference to the consistency group management table 431.

The section 1404 stores the sequential number of the journal lastly written to a secondary volume, or the latest incorporated journal, in the consistency group in the secondary storage system (own system) 220 to which the journal(s) requested to be transferred should belong.

The received sequential number section 1405 stores the sequential number of the lastly received journal in the consistency group in the secondary storage system (own system) 220 to which the journal(s) requested to be transferred should belong, in other words, the sequential number of the latest journal retained in the secondary journal management table 602.

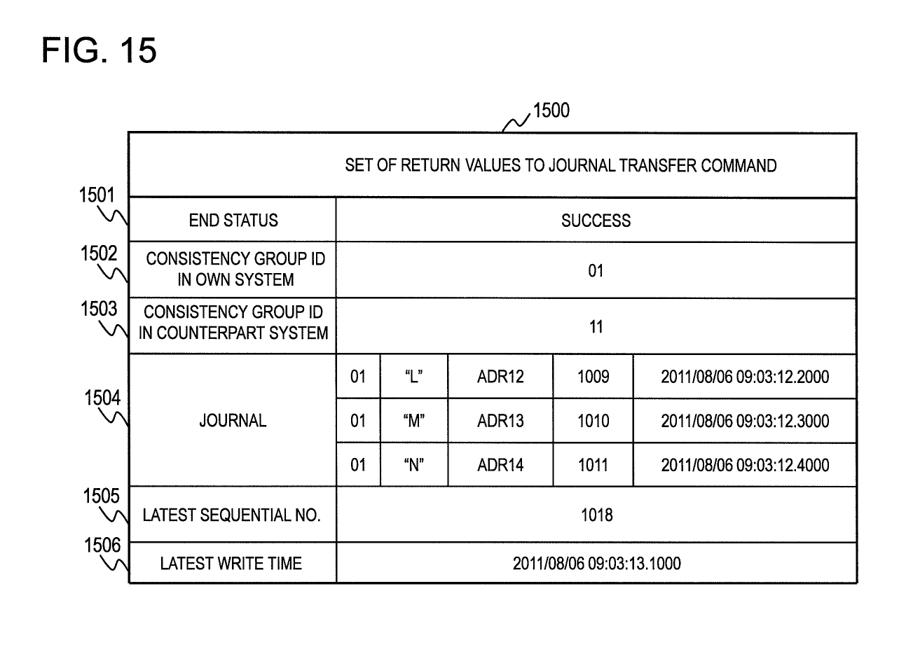

FIG. 15 illustrates an exemplary configuration of a set of return values (a response) 1500 to a journal transfer command. The journal transfer program 424 in the primary storage system 120 sends the set of return values 1500 for a response to a journal transfer command to the secondary storage system 220.

The set of return values 1500 includes a section 1501 of an end status, a section 1502 of a consistency group ID in the own storage system, a section 1503 of a consistency group ID in the counterpart storage system, a section 1504 of journals, a section 1505 of the latest sequential number, and a section 1506 of the latest write time.

The end status section 1501 stores data indicating whether the response to the command is successful or failed. The own system's consistency group ID section 1502 and the counterpart system's consistency group ID section 1503 store the consistency group of the requested journal(s) in the primary storage system 120 and the consistency group of the requested journal(s) in the secondary storage system 220, respectively.

These values are the same as the values in the section 1403 of a consistency group ID in the counterpart system and the section 1402 of a consistency group ID in the own system in the journal transfer command 1400. The journal section 1504 includes one or more journals to be transferred in response to the journal transfer command. In the example of FIG. 15, three journals are included.

The latest sequential number section 1505 indicates the sequential number of the latest journal in the consistency group identified with the own system's consistency group ID. The latest journal is the journal which has been stored lastly to the primary journal management table 601 at the time of receipt of the journal transfer command. The latest write time section 1506 stores information on the write time of the journal having the latest sequential number.

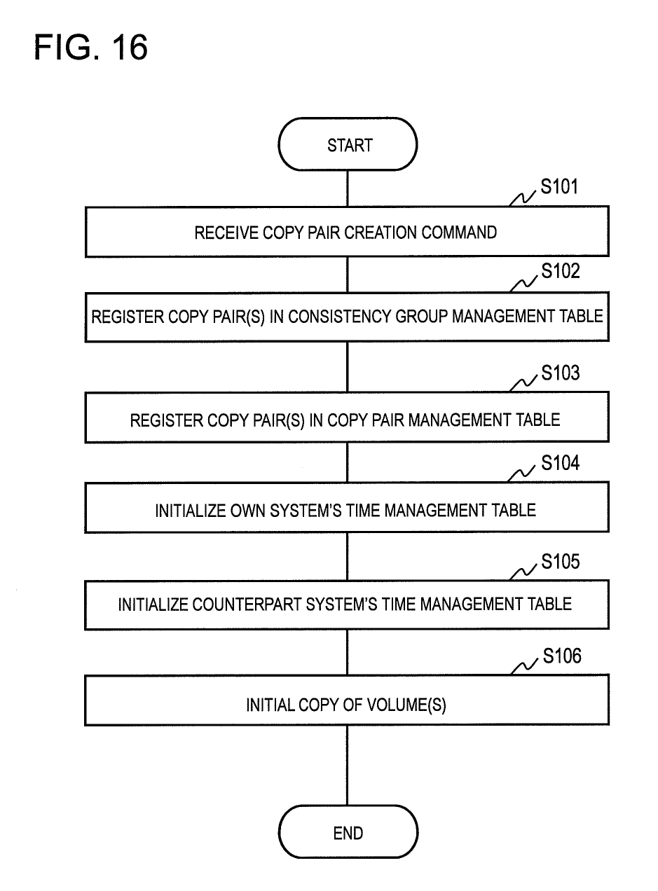

FIG. 16 illustrates a processing flow performed by the copy control program 422 in the primary storage system 120 upon receipt of a command from the management computer 140 to create copy pairs. The administrator adds one or more copy pairs to the copy group management table 311 using the remote copy control program 310 in the management computer 140. The remote copy control program 310 in the management computer 140 sends a command to the primary storage system 120 to create the copy pairs in response to the administrator's input. The copy control program 422 receives the command (S101).

The copy pair creation command designates logical volumes and their consistency groups for the one or more copy pairs to be created in the primary storage system 120 and the secondary storage system 220. Specifically, the copy pair creation command includes respective system IDs, logical volume

IDs, and consistency group IDs with respect to the primary storage system 120 and the secondary storage system 220.

The copy control program 422 in the primary storage system 120 adds the information on the designated copy pairs to the consistency group management table 431 with reference to the received copy pair creation command (S102). Furthermore, the copy control program 422 adds the designated copy pairs to the copy pair management table 432.

The copy control program 422 in the primary storage system 120 accesses the consistency group management table 431 to initialize the own system's time management table 1100 for the newly added consistency group and set an initial value (S104). Furthermore, it initializes the counterpart system's time management table 1200 for the newly added consistency group and sets an initial value in the consistency group management table 431 (S105).

The copy control program 422 in the primary storage system 120 sends a command for initial copy to the secondary storage system 220 designated by the copy pair creation command. The command includes information included in the copy pair creation command received from the management computer 140. The copy control program 422 in the secondary storage system 220 adds new entries to the consistency group management table 431 and the copy pair management table 432 and sets the initial values, like the copy control program 422 in the primary storage system 120.

Thereafter, the copy control programs 422 in the primary storage system 120 and the secondary storage system 220 execute the initial copy of volumes (S106). Through this operation, the copy pairs change their states from Simplex to Duplex.

The administrator may use the management computer 240 in the secondary site to transmit the copy pair creation command from the management computer 240 to the secondary storage system 220. The storage system in each site performs the same processing as that in the above-described example.

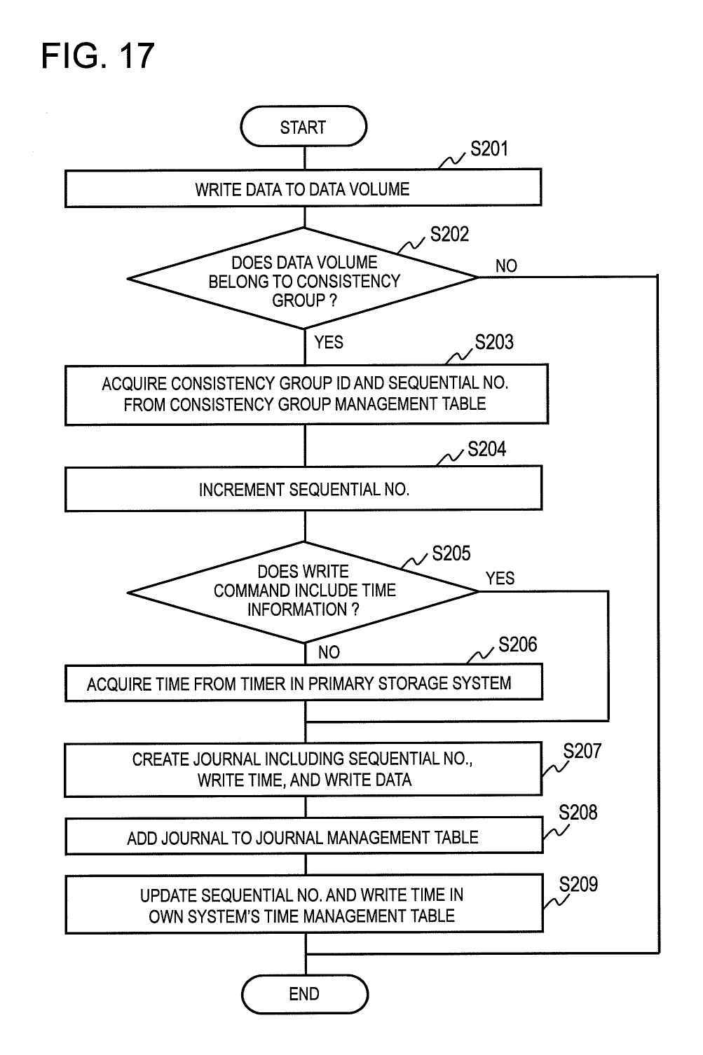

With reference to FIGS. 17 to 20, processing in the primary storage system 120 and the secondary storage system 220 in response to a write command issued by the application server 100 will be explained. Write data is stored in a primary volume and the update in the primary volume is incorporated into a secondary volume.

This processing includes writing the write data to the primary volume, transferring a journal from the primary storage system 120 to the secondary storage system 220, and incorporating the journal into the secondary volume in the secondary storage system 220. As described above, the remote copy in this system is performed asynchronously; these three steps are executed asynchronously.

Before starting detailed explanation of the flowcharts of FIGS. 17 to 20, the outline of the processing will be explained. The input and output control program 421 in the primary storage system 120 creates a journal based on the write command and adds the journal to the primary journal management table 601. The input and output control program 421 updates the own system's time management table 1100 with the time of the write I/O and the sequential number (FIG. 17).

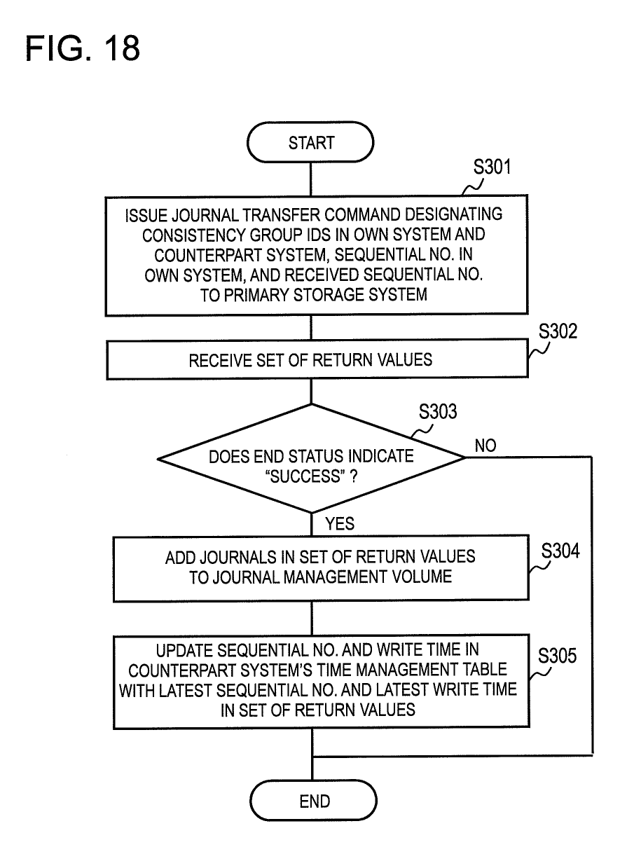

Next, the journal request program 423 in the secondary storage system 220 issues a journal transfer command to the primary storage system 120 to request the primary storage system 120 to transfer created journals to the secondary storage system 220 (FIG. 18). As explained with reference to FIG. 14, the journal transfer command 1400 includes the sequential number of the journal lastly incorporated into the secondary volume in addition to the sequential number of the journal lastly received by the secondary storage system 220.

Upon receipt of the journal transfer command, the journal transfer program 424 in the primary storage system 120 sends journals and information in the own system's time management table 1100 (the write time and the sequential number) to the secondary storage system 220.

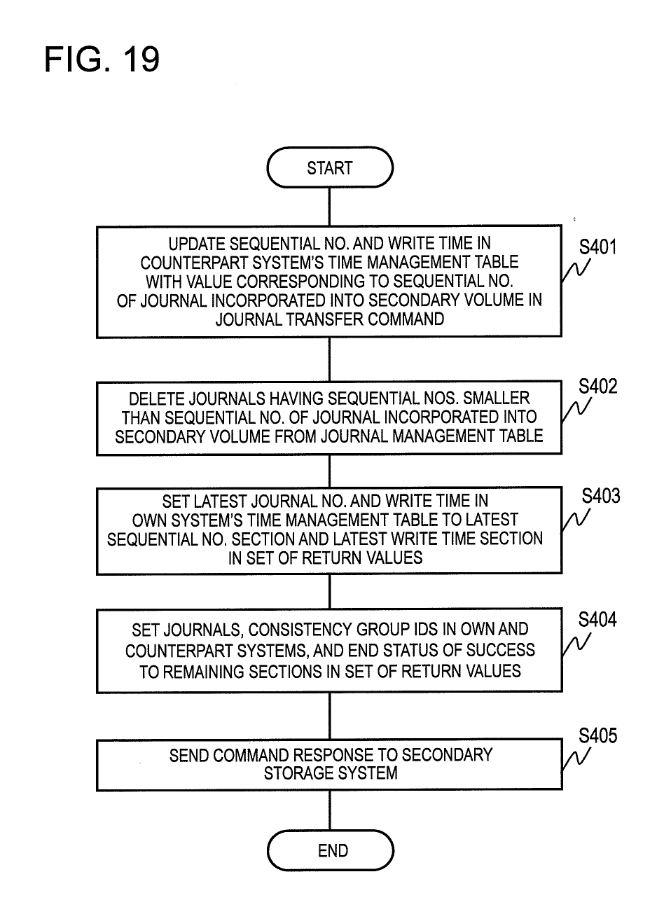

The journal transfer program 424 further searches retrieves the time of the journal having the sequential number of the journal incorporated into the secondary volume included in the journal transfer command (refer to the section 1404 in FIG. 14) from the primary journal management table 601 and updates the write time and the sequential number in the counterpart system's time management table in the primary storage system 120 (FIG. 19).

The journal request program 423 in the secondary storage system 220 adds the journals included in the response from the primary storage system 120 to the secondary journal management table 602. Furthermore, the journal request program 423 sets the sequential number and the write time in the set of return values 1500 to the journal transfer command to the counterpart system's time management table 1200 in the secondary storage system 220 (FIG. 18).

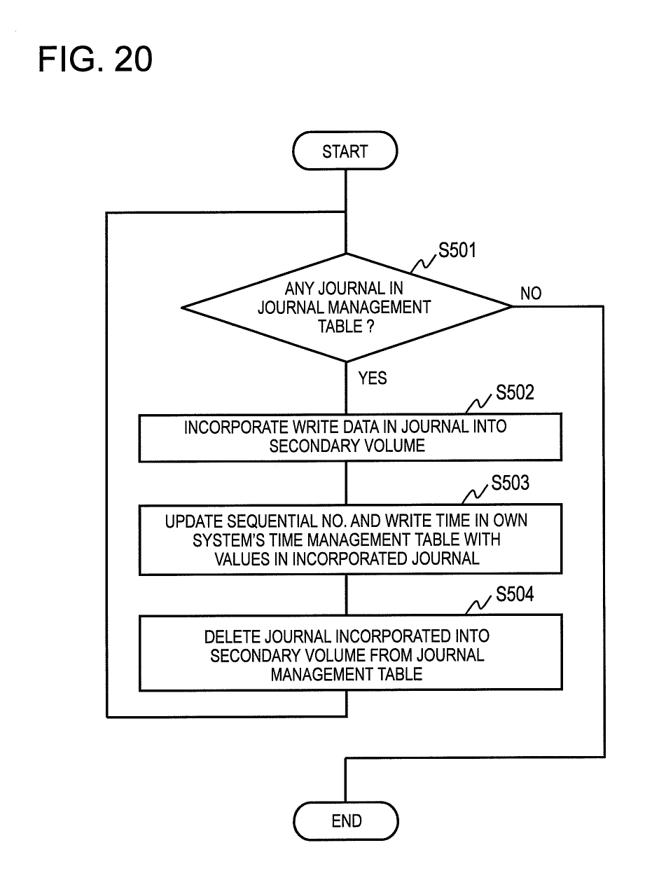

The secondary volume incorporating program 425 in the secondary storage system incorporates the journals in the secondary journal management table 602 into the secondary volume in order of the sequential number. The secondary volume incorporating program 425 updates the own system's time management table 1100 with the write time and the sequential number of the journal incorporated into the secondary volume (FIG. 20).

Hereinafter, details of the flowcharts of FIGS. 17 to 20 will be described. First, with reference to FIG. 17, a flow after the input and output control program 421 in the primary storage system 120 receives a write command from the application server 100 will be described. The application program 107 in the application server 100 issues a write command to a data volume (primary volume) in the primary storage system 120.

The input and output control program 421 writes the write data received from the application program 107 to the data volume at the designated address, for example, a primary volume 121A (S201). The input and output control program 421 ascertains whether the volume designated by the write command belongs to any consistency group with reference to the consistency group management table 431 (S202).

If the volume is not included in any consistency group (NO at S202), the volume is not a volume to be copied; the input and output control program 421 terminates the flow. If the volume is included in any one of the consistency groups (YES at S202), the input and output control program 421 acquires the consistency group ID and the sequential number of the volume (address) designated by the write command from the consistency group management table 431 (S203).

The input and output control program 421 increments the sequential number for the consistency group to which the volume designated by the write command belongs in the consistency group management table 431 (S204). The input and output control program 421 ascertains whether the received write command includes a write time (S205). If the received write command does not include a write time, the input and output control program 421 acquires the time from the timer 416 (S206). If the write command includes a write time, the input and output control program 421 uses this write time.

The input and output control program 421 creates a journal including the consistency group ID and the sequential number acquired from the consistency group management table 431, the write time acquired from the timer 416 or the write command, and the address and the write data acquired from the write command (S207) and adds the journal to the primary journal management table 601 (S208).

The input and output control program 421 further updates the own system's time management table 1100 for the consistency group of the write data (S209). Specifically, the input and output control program 421 updates the values of the sequential number column 1102 and the write time column 1103 for the entry of the above-mentioned consistency group with the sequential number and the write time acquired at the foregoing step.

Next, with reference to the flowchart of FIG. 18, a processing flow of issuing a journal transfer command and obtaining journals will be described. This processing is performed by the journal request program 423 in the secondary storage system 220. The journal request program 423 in the secondary storage system 220 issues a journal transfer command to the primary storage system 120 (S301). As illustrated in FIG. 14, the journal transfer command 1400 includes consistency group IDs in the own system and the counterpart system, a sequential number in the own system, and a received sequential number.

The journal request program 423 receives a set of return values to the transmitted journal transfer command from the primary storage system 120 (S302). The set of return values 1500 has the configuration shown in FIG. 15. The journal request program 423 refers to the section 1501 of the end status in the set of return values 1500 to ascertain whether the end status is SUCCESS (S303).

If the end status is not SUCCESS (NO at S303), the journal request program 423 terminates this flow. If the end status is SUCCESS (YES at S303), the journal request program 423 adds the journals in the set of return values to the journal transfer command to the secondary journal management table 602 (S304).

The journal request program 423 further updates the counterpart system's time management table 1200 with the data of the received journals (S305). Specifically, the journal request program 423 updates the values of the sequential number column 1202 and the write time column 1203 in the entry of the consistency group to which the received journals belong with the latest sequential number and the latest write time in the set of return values to the journal transfer command in the counterpart system's time management table 1200.

Next, with reference to the flowchart of FIG. 19, a processing flow of responding to a journal transfer command will be described. This processing is performed by the journal transfer program 424 in the primary storage system 120. Upon receipt of a journal transfer command, the journal transfer program 424 updates the counterpart system's time management table 1200 with the data included in the command (S401).

Specifically, the journal transfer program 424 acquires the value in the section 1404 of the sequential number of the journal incorporated into the secondary volume in the journal transfer command 1400 and further acquires the value of the write time of the journal having the sequential number in the consistency group indicated by the section 1403 of the consistency group ID in the counterpart system from the primary journal management table 601.

The journal transfer program 424 updates, in the counterpart system's time management table 1200, the values in the sequential number column 1202 and the write time column 1203 in the entry of the consistency group indicated by the journal transfer command with the acquired values.

The journal transfer program 424 deletes the journals having the sequence numbers smaller than the sequence number indicated in the section 1404 of the sequential number incorporated into the secondary volume in the consistency group indicated in the section 1403 of the consistency group ID in the counterpart system from the primary journal management table 601 (S402). Since these journals have already been incorporated into the secondary volume, the program reduces the required capacity. The journal transfer program 424 does not have to delete the journals.

The journal transfer program 424 creates a set of return values (a response) to the journal transfer command (S403, 5404) and sends it to the primary storage system 120 (S405). Specifically, the journal transfer program 424 sets the value in the sequential number column 1102 for the relevant consistency group in the own system's time management table 1100 to the latest sequential number section 1505 in the set of return values 1500 and sets the value in write time column 1103 to the latest write time section 1506 (S403).

The journal transfer program 424 sets the consistency group IDs designated by the journal transfer command 1400 to the section 1502 of the consistency group ID in the own system and the section 1503 of the consistency group ID in the counterpart system in the set of return values 1500.

The journal transfer program 424 further sets SUCCESS to the end status section 1501 and stores the journals to be transferred in the journal section 1504 (S404). The journal transfer program 424 issues the created set of return values 1500 to the secondary storage system (S405).

Next, with reference to the flowchart of FIG. 20, a processing flow of incorporating a journal into the secondary volume will be described. This processing is performed by the secondary volume incorporating program 425 in the secondary storage system. The secondary volume incorporating program 425 ascertains whether the secondary journal management table 602 contains a journal (S501).

If the table does not contain a journal (NO at S501), the secondary volume incorporating program 425 terminates this flow. If it contains a journal (YES at S501), the secondary volume incorporating program 425 incorporates the write data in the journal into the secondary volume (S502).

The secondary volume incorporating program 425 further updates the values in the sequential number column 1102 and the write time column 1103 in the entry of the consistency group of the journal incorporated into the secondary volume with the values of the sequential number and the write time in the incorporated journal (S503). The secondary volume incorporating program 425 deletes the journal that has been incorporated into the secondary volume from the secondary journal management table 602 (S504).

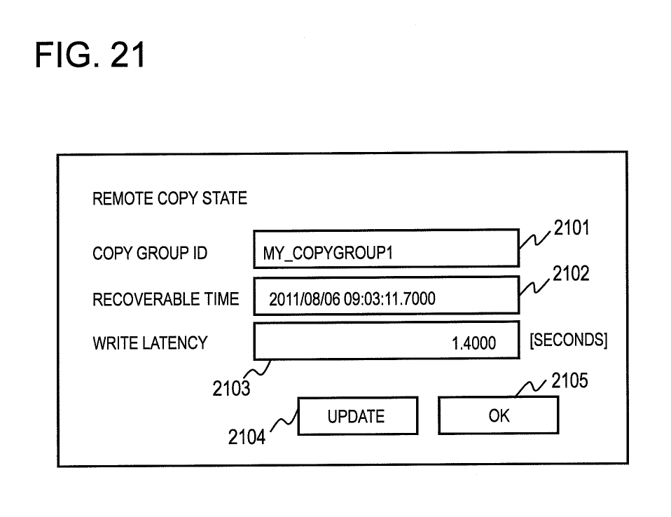

Hereinafter, methods of calculating and presenting a data recoverable time and a write latency in asynchronous remote copy will be described. FIG. 21 is an exemplary image that the remote copy control program 310 in the management computer 140 or 240 presents at the image output device 305. In the image of FIG. 21, the administrator enters a value in the field 2101 of the copy group ID using the input device 306 and press the update button 2104.

The remote copy control program 310 obtains a recoverable time and a write latency for the consistency group identified with the entered copy group ID and shows the values in the field 2102 of the recoverable time field and the field 2103 of the write latency. The administrator presses the OK button 2105 with the input apparatus 306 to close the window.

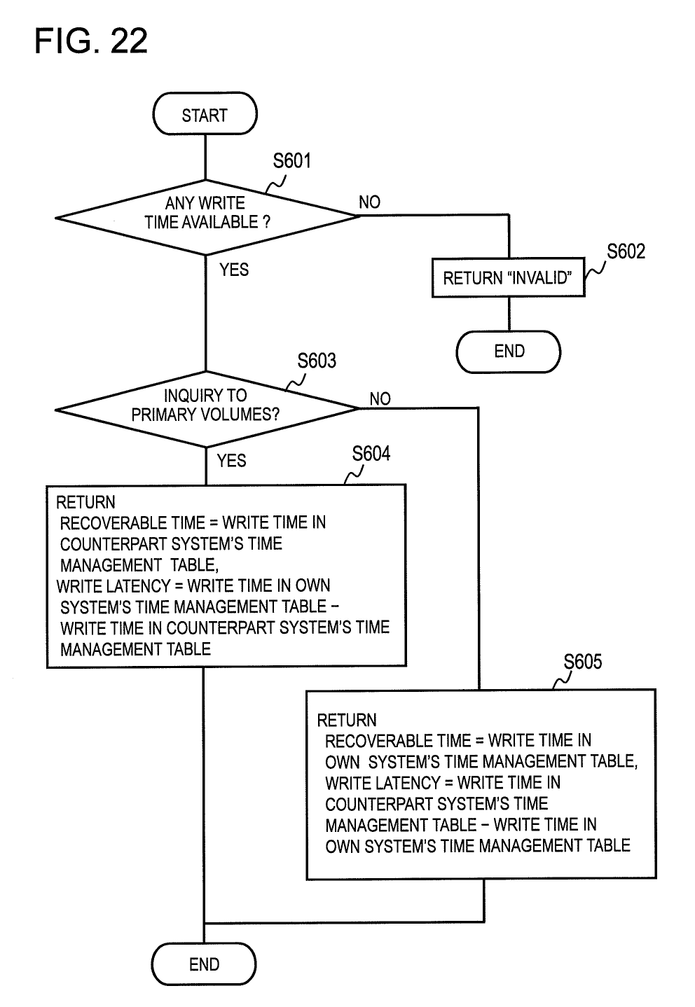

With reference to the flowchart of FIG. 22, a method of calculating a recoverable time and a write latency will be described. FIG. 22 illustrates a flow performed by the recovery point objective calculation program 426 when the primary storage system 120 or the secondary storage system 220 receives a command inquiring the recoverable time and the write latency from the management computer 140 or 240.

Upon a press of the update button 2104, the remote copy control program 310 in the management computer 140 or 240 identifies the consistency group ID for the copy group ID entered by the administrator with reference to the copy group management table 311. The remote copy control program 310 sends a command including the identified consistency group ID, the own storage system ID, and the command destination storage system ID to the primary storage system 120 or the secondary storage system 220.

The recovery point objective calculation program 426 starts the flow shown in FIG. 22 for the consistency group ID included in the received command. The recovery point objective calculation program 426 ascertains whether a write time is provided for the designated consistency group ID with reference to the consistency group management table 431 (S601). If no write time is provided (NO at S601), it returns a value INVALID to the management computer 140 or 240 of the inquiry source (S602).

If a write time is provided (YES at S601), the recovery point objective calculation program 426 ascertains whether the consistency group ID in the inquiry is a consistency group ID for primary volumes or a consistency group ID for secondary volumes (S603). This is because a storage system can have both functions of the primary storage system and the secondary storage system and have both primary volumes and secondary volumes.

The recovery point objective calculation program 426 identifies the IDs of the logical volumes included in the consistency group designated by the command with reference to the consistency group management table 432. Furthermore, it ascertains whether the identified logical volume IDs are the IDs for primary volumes or secondary volumes.

If the consistency group ID in the inquiry is a consistency group for primary volumes (YES at S603), the recovery point objective calculation program 426 calculates the recoverable time and the write latency by the following calculation. Moreover, the recovery point objective calculation program 426 sends a set of return values including values of the calculated recoverable time and the write latency to the remote copy control program 310 in the management computer 140 or 240 (S604).

Recoverable time=Write time in the counterpart system's time management table

Write latency=Write time in the own system's time management table−Write time in the counterpart system's time management table

The recoverable time is a value in the write time column 1203 in the entry of the consistency group ID in the inquiry in the counterpart system's time management table 1200. The write latency is a difference between the value in the write time column 1103 in the entry of the consistency group ID in the inquiry in the own system's time management table 1100 and the value in the write time column 1203 in the entry of the same consistency group ID in the counterpart system's time management table 1200.

If the consistency group ID in the inquiry is a consistency group for secondary volumes (NO at S603), the recovery point objective calculation program 426 calculates the recoverable time and the write latency by the following calculation. Moreover, the recovery point objective calculation program 426 sends a set of return values including the values of the calculated recoverable time and the write latency to the remote copy control program 310 in the management computer 140 or 240 (S605).

Recoverable time=Write time in the own system's time management table

Write latency=Write time in the counterpart system's time management table−Write time in the own system's time management table

The recoverable time is a value in the write time column 1103 in the entry of the consistency group ID in the inquiry in the own system's time management table 1100. The write latency is a difference between the value in the write time column 1203 in the entry of the consistency group ID in the inquiry in the counterpart system's time management table 1200 and the value in the write time column 1103 in the entry of the same consistency group ID in the own system's time management table 1100.

According to this embodiment, a proper write latency and recoverable time can be obtained and monitored in a system that performs asynchronous remote copy. A journal transfer command or a set of return values thereto is transferred inclusive of information to be used in calculating the write latency, so that increase in the load to the storage systems or the networks caused by monitoring the write latency can be lowered.

As set forth above, this invention has been described with reference to the accompanying drawings; however, this invention is not limited to such a specific configuration but includes various modifications and equivalent configurations within the scope of the appended claims. The programs, for all or a part of them, may be implemented by dedicated hardware. The programs can be installed in the computers through a program distribution server or a computer-readable non-transitory medium and stored in non-volatile external storage devices of the computers.

The above-described computer system can acquire information on the recoverable time and the write latency from both of the primary storage system and the secondary storage system; however, it may be configured to acquire such information from either one of them. The system may transfer information on the latest write data in either a journal transfer command or the set of return values thereto.

The computer system may incorporate the sequential number of the latest journal in the secondary volumes into a frame different from a journal transfer command to transfer it from the secondary storage system to the primary storage system.

The system may incorporate the sequential number of the latest journal in the primary volumes into a frame different from a set of return values to a journal transfer command to transfer it to the secondary storage system. A set of return values to a journal transfer command does not need to include information for identifying a journal or write data as far as it includes information on the write time.

The computer system may use identification information different from a sequential number for identifying a journal or write data to calculate a write latency. The primary storage system does not need to incorporate information on the write time into a journal and it can manage the write times of write data independent from journals.

A management system may perform a part of the processing performed by the storage systems. In the above-described example, the storage system calculates the recoverable time and the write latency but the management system may perform those calculations. The management system acquires information to calculate these values from the storage systems via the networks. The recoverable time, the write latency, and information to calculate them are information to provide the recoverable time and the write latency.

What is claimed is:

1. A computer system comprising:
a primary storage system including one or more primary volumes;
a secondary storage system including one or more secondary volumes for storing copy data of the one or more primary volumes received from the primary storage system via a network; and
a management system for managing the primary storage system,
wherein the primary storage system manages write times of write data of the one or more primary volumes,
wherein the primary storage system sequentially sends journals, which include write data of the one or more primary volumes and values indicating order of writing the write data to the one or more primary volumes, to the secondary storage system,
wherein the secondary storage system sequentially stores the write data included in the journals received from the primary storage system to the one or more secondary volumes in accordance with the values indicating the order of writing,
wherein the secondary storage system sends identification information on the latest write data of the one or more secondary volumes to the primary storage system, and
wherein the primary storage system sends the management system information to indicate a latency between the write time of the write data identified with the identification information and the write time of the latest write data of the one or more primary volumes at the time of receipt of the identification information.

2. A computer system according to claim 1,
wherein the secondary storage system sends the primary storage system a journal transfer command,
wherein the primary storage system sends a journal in response to the journal transfer command, and
wherein the secondary storage system sends the primary storage system the identification information included in the journal transfer command.

3. A computer system according to claim 1,
wherein the primary storage system calculates the latency between the write time of the write data identified with the identification information and the write time of the latest write data of the one or more primary volumes at the time of receipt of the identification information, and
wherein the information to indicate the latency includes the calculated latency.

4. A computer system according to claim 1,
wherein the primary storage system includes one or more consistency groups each of which consists of one or more primary volumes,
wherein the secondary storage system includes one or more consistency groups each of which consists of one or more secondary volumes and corresponds to each of the one or more consistency groups in the primary storage system,
wherein the primary storage system and the secondary storage system manage the order of writing write data in each consistency group, and
wherein the primary storage system sends the management system the information to indicate the latency in each consistency group in the primary storage system.

5. A computer system according to claim 2,
wherein the primary storage system includes journal management information for storing journals of the one or more primary volumes, and
wherein the primary storage system deletes the journal of the write data identified with the identification information and journals preceding the journal of the write data identified with the identification information for the one or more primary volumes from the journal management information.

6. A computer system according to claim 1,
wherein the primary storage system further includes a timer, and
wherein the primary storage system determines that a time which the timer indicates after receipt of the write data is the write time.

7. A computer system according to claim 1,
wherein the primary storage system further includes a timer,
wherein the primary storage system determines whether a received write command includes time information, and
wherein, in a case where the write command includes time information, the primary storage system determines that the time indicated by the time information is the write time and, in a case where the write command does not include time information, the primary storage system determines that the time indicated by the timer is the write time.

8. A computer system according to claim 1,
wherein a journal transferred from the primary storage system to the secondary storage system further includes information on write time of write data included in the journal,
wherein the primary storage system sends the secondary storage system the write time of the latest write data of the one or more primary volumes, and
wherein the secondary storage system sends information capable of indicating a latency between the received write time and the write time of the latest write data of the one or more secondary volumes to a management system for managing the secondary storage system.

9. A computer system according to claim 8,
wherein the secondary storage system sends the primary storage system a journal transfer command,
wherein the primary storage system sends a set of return values including a journal in response to the journal transfer command, and
wherein the primary storage system sends the secondary storage system the write time included in the set of return values.

10. A computer system according to claim 1, wherein the management system determines the latency from the information to indicate the latency and displays the latency with a display device.

11. A computer system according to claim 1, wherein the identification information is the value indicating the order of writing included in the journal for the latest write data of the one or more secondary volumes that has been transferred from the primary storage system to the secondary storage system.

12. A computer system comprising:
a primary storage system including one or more primary volumes;
a secondary storage system which communicates with the primary storage system via a network and includes one or more secondary volumes for storing copy data of the one or more primary volumes; and
a management system for managing the secondary storage system,
wherein the primary storage system manages write times of write data to the one or more primary volumes,
wherein the primary storage system sequentially sends the secondary storage system journals including write data to the one or more primary volumes, values indicating order of writing the write data to the one or more primary volumes, and the write times of the write data,
wherein the secondary storage system sequentially stores the write data included in the journals received from the primary storage system to the one or more secondary volumes in accordance with the values indicating the order of writing,
wherein the primary storage system sends the secondary storage system a write time of the latest write data to the one or more primary volumes, and
wherein the secondary storage system sends the management system information to indicate a latency between the received write time and the write time of the latest write data stored in the one or more secondary volumes.

13. A computer system according to claim 12,
wherein the secondary storage system sends the primary storage system a journal transfer command,
wherein the primary storage system sends a set of return values including journals in response to the journal transfer command, and
wherein the primary storage system sends the secondary storage system the write times included in the set of return values.
